(19) United States
(12) Patent Application Publication
(10) Pub. No.: US 2025/0102693 A1
(43) Pub. Date: Mar. 27, 2025

(54) AUTOMATED ACTIVE LEARNING FOR SEISMIC IMAGE INTERPRETATION

(71) Applicant: Schlumberger Technology Corporation, Sugar Land, TX (US)

(72) Inventors: Haibin Di, Houston, TX (US); Aria Abubakar, Sugar Land, TX (US)

(21) Appl. No.: 18/832,810

(22) PCT Filed: Mar. 24, 2023
(86) PCT No.: PCT/US2023/016249

§ 371 Date: Jul. 24, 2024

Related U.S. Application Data
(60) Provisional application No. 63/269,885, filed on Mar. 24, 2022.

(51) Int. Cl. G01V 1/30; G06T 7/00; G06T 11/20

(52) U.S. Cl. CPC G01V 1/301; G06T 7/0002; G06T 11/206; G06T 2207/20081; G06T 2207/30181

(57) ABSTRACT

A method includes receiving seismic data and an attribute, the seismic data and the attribute representing a subsurface volume, receiving training labels for the seismic data, training a machine learning model to identify features in the subsurface volume and to reconstruct the attribute, based at least in part on the seismic data and the training labels, generating an interpretation by predicting features in the subsurface volume using the machine learning model, generating a reconstructed attribute using the machine learning model, comparing the reconstructed attribute with the attribute that was received to identify one or more sections of the subsurface volume, and generating a recommendation to acquire additional training labels in the one or more sections that were identified.

### CROSS-REFERENCE TO RELATED APPLICATIONS

This application claims priority to U.S. Provisional Patent Application having Ser. No. 63/269,885, which was filed on Mar. 24, 2022, and is incorporated herein by reference in its entirety.

### BACKGROUND

Subsurface mapping is used in a variety of contexts to characterize the properties of a subterranean volume of interest. One way this is done is through seismic imaging. Seismic data is received in a seismic survey, and the seismic data may then be processed to generate two or three dimensional images of the subsurface. The images may then be interpreted, e.g., to identify geological features in the subsurface and, e.g., generate a facies model.

Advances have been made recently in computer-aided seismic interpretation, and a set of automated tools have been developed that greatly accelerate the process of seismic interpretation, including 3D visualization, horizon tracking, fault picking, facies analysis, and others. More recently, deep learning, particularly convolutional neural networks (CNN), has enabled techniques that include interpreting a seismic volume directly from its amplitude data with relatively little user interaction, using deterministic seismic attributes. This has been used in fault detection, salt body delineation, horizon tracking, and sequence analysis, and potentially other contexts.

These interpretation CNNs generally implement supervised learning, calling for a human user (“interpreter”) to annotate a set of seismic sections as training data. The human aspect of these processes can present a challenge, because the annotated sections that the training relies on may represent a small sampling of an entire seismic volume and thus may not accurately represent of the complexities in seismic patterns throughout the seismic survey.

In such a case, although a CNN effectively learns from the annotated sections, its prediction on the sections far away from these training inputs may have a relatively low accuracy. To improve the accuracy, one strategy is to expand the training data by sorting out and guiding an interpreter to annotating these challenging sections, re-training and evaluating the CNN, and repeating the process until the machine prediction becomes acceptable. For such iterative seismic interpretation, active learning (AL) may be employed, in which a CNN can interactively query an expert to annotate new seismic sections where its prediction is least accurate. However, without a volumetric annotation for quantitative analysis, such section-wise evaluation of CNN prediction depends on visual screening based on the interpreter's knowledge, which is both labor intensive and subjective.

### SUMMARY

Embodiments of the disclosure include a method that includes receiving seismic data and an attribute, the seismic data and the attribute representing a subsurface volume, receiving training labels for the seismic data, training a machine learning model to identify features in the subsurface volume and to reconstruct the attribute, based at least in part on the seismic data and the training labels, generating an interpretation by predicting features in the subsurface volume using the machine learning model, generating a reconstructed attribute using the machine learning model, comparing the reconstructed attribute with the attribute that was received to identify one or more sections of the subsurface volume, and generating a recommendation to acquire additional training labels in the one or more sections that were identified.

Embodiments of the disclosure include a computing system that includes one or more processors, and a memory system including one or more non-transitory, computer-readable media storing instructions that, when executed by at least one of the one or more processors, cause the computing system to perform operations. The operations include receiving seismic data and an attribute, the seismic data and the attribute representing a subsurface volume, receiving training labels for the seismic data, training a machine learning model to identify features in the subsurface volume and to reconstruct the attribute, based at least in part on the seismic data and the training labels, generating an interpretation by predicting features in the subsurface volume using the machine learning model, generating a reconstructed attribute using the machine learning model, comparing the reconstructed attribute with the attribute that was received to identify one or more sections of the subsurface volume, and generating a recommendation to acquire additional training labels in the one or more sections that were identified.

Embodiments of the disclosure include a non-transitory, computer-readable media storing instructions that, when executed by at least one processor of a computing system, cause the computing system to perform operations. The operations include receiving seismic data and an attribute, the seismic data and the attribute representing a subsurface volume, receiving training labels for the seismic data, training a machine learning model to identify features in the subsurface volume and to reconstruct the attribute, based at least in part on the seismic data and the training labels, generating an interpretation by predicting features in the subsurface volume using the machine learning model, generating a reconstructed attribute using the machine learning model, comparing the reconstructed attribute with the attribute that was received to identify one or more sections of the subsurface volume, and generating a recommendation to acquire additional training labels in the one or more sections that were identified.

Thus, the computing systems and methods disclosed herein are more effective methods for processing collected data that may, for example, correspond to a surface and a subsurface region. These computing systems and methods increase data processing effectiveness, efficiency, and accuracy. Such methods and computing systems may complement or replace conventional methods for processing collected data. This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIGS. 1A, 1B, 1C, 1D, 2, 3A, and 3B illustrate simplified, schematic views of an oilfield and its operation, according to an embodiment.

FIG. 4 illustrates a workflow for generating a seismic interpretation of a subsurface volume using adaptive learning, according to an embodiment.

FIG. 5 illustrates an architecture for a machine learning model for seismic interpretation of a subsurface volume, according to an embodiment.

FIG. 6 illustrates a flowchart of a method for generating a model (e.g., a seismic interpretation) using adaptive learning, according to an embodiment.

FIG. 7 illustrates a plot of mean squared error (MSE) of a reconstructed relative geologic time and a plot of a machine learning accuracy score (F1) of the predicted interpolation, according to an embodiment.

FIGS. 8A and 8B illustrate an actual relative geologic time (RGT) image and a reconstructed RGT map, according to an embodiment.

FIGS. 8C and 8D illustrate an actual facies image and a reconstructed facies image, according to an embodiment.

FIG. 9 illustrates a table of statistics for an example implementation of the present disclosure.

FIG. 10 illustrates a schematic view of a computing system, according to an embodiment.

### DESCRIPTION OF EMBODIMENTS

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object could be termed a second object, and, similarly, a second object could be termed a first object, without departing from the scope of the invention. The first object and the second object are both objects, respectively, but they are not to be considered the same object.

The terminology used in the description of an embodiment of the invention herein is for the purpose of describing particular embodiments only and is not intended to be limiting of the invention. As used in the description of embodiments of the invention and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques and workflows that are in accordance with some embodiments. Some operations in the processing procedures, methods, techniques and workflows disclosed herein may be combined and/or the order of some operations may be changed.

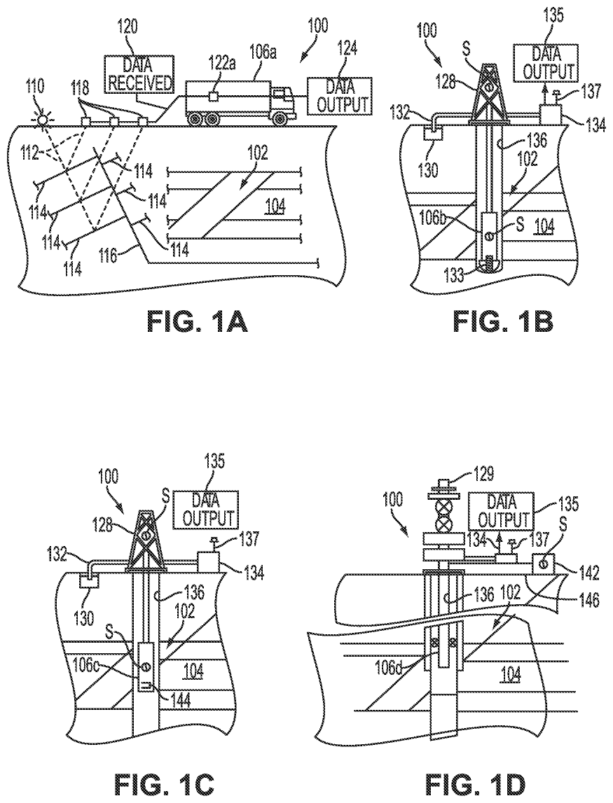

FIGS. 1A-1D illustrate simplified, schematic views of oilfield 100 having subterranean formation 102 containing reservoir 104 therein in accordance with implementations of various technologies and techniques described herein. FIG. 1A illustrates a survey operation being performed by a survey tool, such as seismic truck 106a, to measure properties of the subterranean formation. The survey operation is a seismic survey operation for producing sound vibrations. In FIG. 1A, one such sound vibration, e.g., sound vibration 112 generated by source 110, reflects off horizons 114 in earth formation 116. A set of sound vibrations is received by sensors, such as geophone-receivers 118, situated on the earth's surface. The data received 120 is provided as input data to a computer 122a of a seismic truck 106a, and responsive to the input data, computer 122a generates seismic data output 124. This seismic data output may be stored, transmitted or further processed as desired, for example, by data reduction.

FIG. 1B illustrates a drilling operation being performed by drilling tools 106b suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud is typically filtered and returned to the mud pit. A circulating system may be used for storing, controlling, or filtering the flowing drilling mud. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produce data output 135, which may then be stored or transmitted.

Sensors (S), such as gauges, may be positioned about oilfield 100 to collect data relating to various oilfield operations as described previously. As shown, sensor (S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors (S) may also be positioned in one or more locations in the circulating system.

Drilling tools 106b may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Typically, the wellbore is drilled according to a drilling plan that is established prior to drilling. The drilling plan typically sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected.

The data gathered by sensors (S) may be collected by surface unit 134 and/or other data collection sources for analysis or other processing. The data collected by sensors (S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In some cases, well plans may be adjusted to select optimum (or improved) operating conditions, or to avoid problems.

FIG. 1C illustrates a wireline operation being performed by wireline tool 106c suspended by rig 128 and into wellbore 136 of FIG. 1B. Wireline tool 106c is adapted for deployment into wellbore 136 for generating well logs, performing downhole tests and/or collecting samples. Wireline tool 106c may be used to provide another method and apparatus for performing a seismic survey operation. Wireline tool 106c may, for example, have an explosive, radioactive, electrical, or acoustic energy source 144 that sends and/or receives electrical signals to surrounding subterranean formations 102 and fluids therein.

Wireline tool 106c may be operatively connected to, for example, geophones 118 and a computer 122a of a seismic truck 106a of FIG. 1A. Wireline tool 106c may also provide data to surface unit 134. Surface unit 134 may collect data generated during the wireline operation and may produce data output 135 that may be stored or transmitted. Wireline tool 106c may be positioned at various depths in the wellbore 136 to provide a survey or other information relating to the subterranean formation 102.

Sensors (S), such as gauges, may be positioned about oilfield 100 to collect data relating to various field operations as described previously. As shown, sensor S is positioned in wireline tool 106c to measure downhole parameters which relate to, for example porosity, permeability, fluid composition and/or other parameters of the field operation.

FIG. 1D illustrates a production operation being performed by production tool 106d deployed from a production unit or Christmas tree 129 and into completed wellbore 136 for drawing fluid from the downhole reservoirs into surface facilities 142. The fluid flows from reservoir 104 through perforations in the casing (not shown) and into production tool 106d in wellbore 136 and to surface facilities 142 via gathering network 146.

Sensors (S), such as gauges, may be positioned about oilfield 100 to collect data relating to various field operations as described previously. As shown, the sensor (S) may be positioned in production tool 106d or associated equipment, such as Christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 1B-1D illustrate tools used to measure properties of an oilfield, it will be appreciated that the tools may be used in connection with non-oilfield operations, such as gas fields, mines, aquifers, storage or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors (S) may be located at various positions along the wellbore and/or the monitoring tools to collect and/or monitor the desired data. Other sources of data may also be provided from offsite locations.

The field configurations of FIGS. 1A-1D are intended to provide a brief description of an example of a field usable with oilfield application frameworks. Part of, or the entirety, of oilfield 100 may be on land, water and/or sea. Also, while a single field measured at a single location is depicted, oilfield applications may be utilized with any combination of one or more oilfields, one or more processing facilities and one or more wellsites.

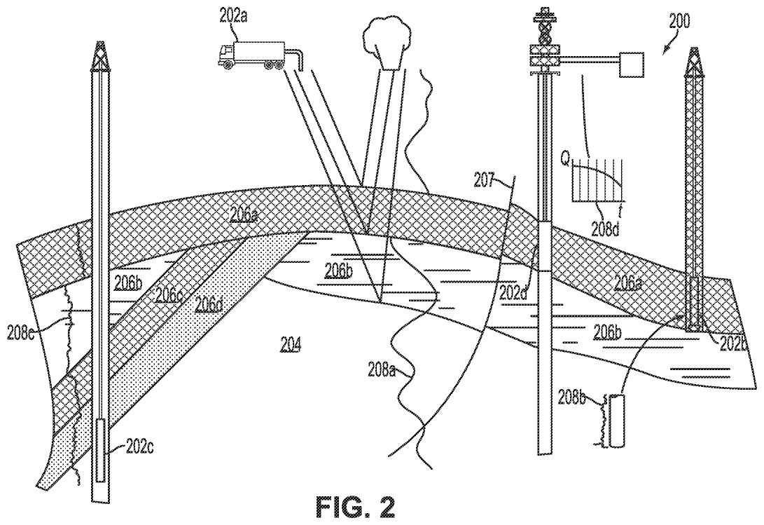

FIG. 2 illustrates a schematic view, partially in cross section of oilfield 200 having data acquisition tools 202a, 202b, 202c and 202d positioned at various locations along oilfield 200 for collecting data of subterranean formation 204 in accordance with implementations of various technologies and techniques described herein. Data acquisition tools 202a-202d may be the same as data acquisition tools 106a-106d of FIGS. 1A-1D, respectively, or others not depicted. As shown, data acquisition tools 202a-202d generate data plots or measurements 208a-208d, respectively. These data plots are depicted along oilfield 200 to demonstrate the data generated by the various operations.

Data plots 208a-208c are examples of static data plots that may be generated by data acquisition tools 202a-202c, respectively; however, it should be understood that data plots 208a-208c may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208a is a seismic two-way response over a period of time. Static plot 208b is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208c is a logging trace that typically provides a resistivity or other measurement of the formation at various depths.

A production decline curve or graph 208d is a dynamic data plot of the fluid flow rate over time. The production decline curve typically provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206a-206d. As shown, this structure has several formations or layers, including a shale layer 206a, a carbonate layer 206b, a shale layer 206c and a sand layer 206d. A fault 207 extends through the shale layer 206a and the carbonate layer 206b. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, typically below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 2, may then be processed and/or evaluated. Typically, seismic data displayed in static data plot 208a from data acquisition tool 202a is used by a geophysicist to determine characteristics of the subterranean formations and features. The core data shown in static plot 208b and/or log data from well log 208c are typically used by a geologist to determine various characteristics of the subterranean formation. The production data from graph 208d is typically used by the reservoir engineer to determine fluid flow reservoir characteristics. The data analyzed by the geologist, geophysicist and the reservoir engineer may be analyzed using modeling techniques.

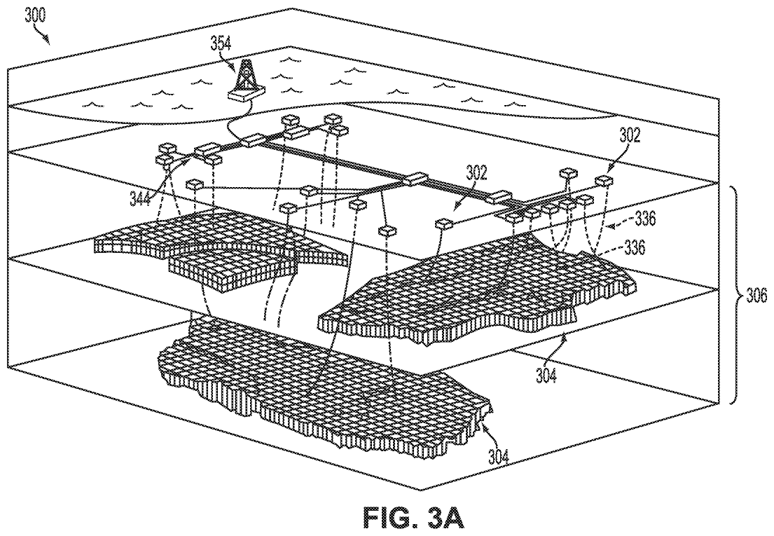

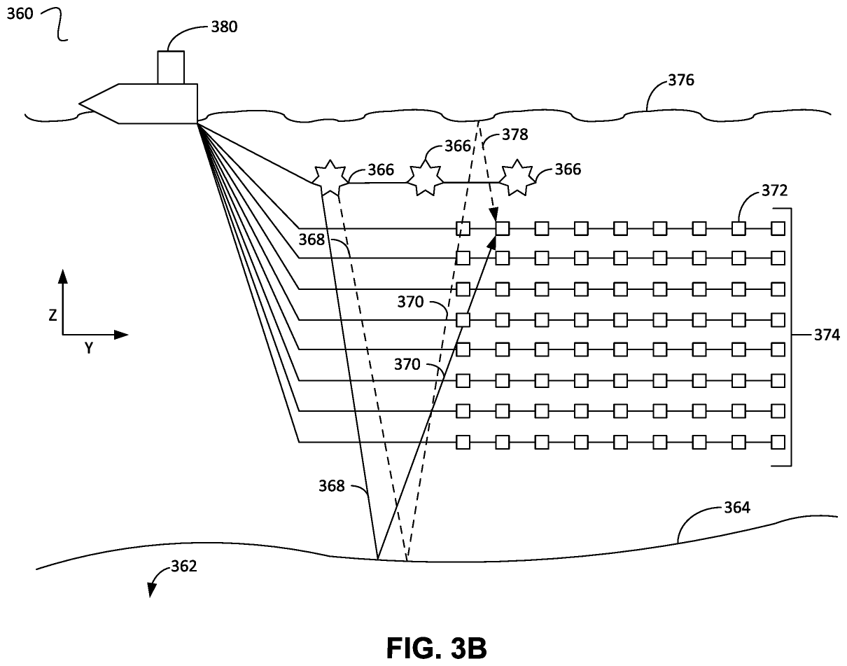

FIG. 3A illustrates an oilfield 300 for performing production operations in accordance with implementations of various technologies and techniques described herein. As shown, the oilfield has a plurality of wellsites 302 operatively connected to central processing facility 354. The oilfield configuration of FIG. 3A is not intended to limit the scope of the oilfield application system. Part, or all, of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the Earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

Attention is now directed to FIG. 3B, which illustrates a side view of a marine-based survey 360 of a subterranean subsurface 362 in accordance with one or more implementations of various techniques described herein. Subsurface 362 includes seafloor surface 364. Seismic sources 366 may include marine sources such as vibroseis or airguns, which may propagate seismic waves 368 (e.g., energy signals) into the Earth over an extended period of time or at a nearly instantaneous energy provided by impulsive sources. The seismic waves may be propagated by marine sources as a frequency sweep signal. For example, marine sources of the vibroseis type may initially emit a seismic wave at a low frequency (e.g., 5 Hz) and increase the seismic wave to a high frequency (e.g., 80-90 Hz) over time.

The component(s) of the seismic waves 368 may be reflected and converted by seafloor surface 364 (i.e., reflector), and seismic wave reflections 370 may be received by a plurality of seismic receivers 372. Seismic receivers 372 may be disposed on a plurality of streamers (i.e., streamer array 374). The seismic receivers 372 may generate electrical signals representative of the received seismic wave reflections 370. The electrical signals may be embedded with information regarding the subsurface 362 and captured as a record of seismic data.

In one implementation, each streamer may include streamer steering devices such as a bird, a deflector, a tail buoy and the like, which are not illustrated in this application. The streamer steering devices may be used to control the position of the streamers in accordance with the techniques described herein.

In one implementation, seismic wave reflections 370 may travel upward and reach the water/air interface at the water surface 376, a portion of reflections 370 may then reflect downward again (i.e., sea-surface ghost waves 378) and be received by the plurality of seismic receivers 372. The sea-surface ghost waves 378 may be referred to as surface multiples. The point on the water surface 376 at which the wave is reflected downward is generally referred to as the downward reflection point.

The electrical signals may be transmitted to a vessel 380 via transmission cables, wireless communication or the like. The vessel 380 may then transmit the electrical signals to a data processing center. Alternatively, the vessel 380 may include an onboard computer capable of processing the electrical signals (i.e., seismic data). Those skilled in the art having the benefit of this disclosure will appreciate that this illustration is highly idealized. For instance, surveys may be of formations deep beneath the surface. The formations may typically include multiple reflectors, some of which may include dipping events, and may generate multiple reflections (including wave conversion) for receipt by the seismic receivers 372. In one implementation, the seismic data may be processed to generate a seismic image of the subsurface 362.

Marine seismic acquisition systems tow each streamer in streamer array 374 at the same depth (e.g., 5-10 m). However, marine-based survey 360 may tow each streamer in streamer array 374 at different depths such that seismic data may be acquired and processed in a manner that avoids the effects of destructive interference due to sea-surface ghost waves. For instance, marine-based survey 360 of FIG. 3B illustrates eight streamers towed by vessel 380 at eight different depths. The depth of each streamer may be controlled and maintained using the birds disposed on each streamer.

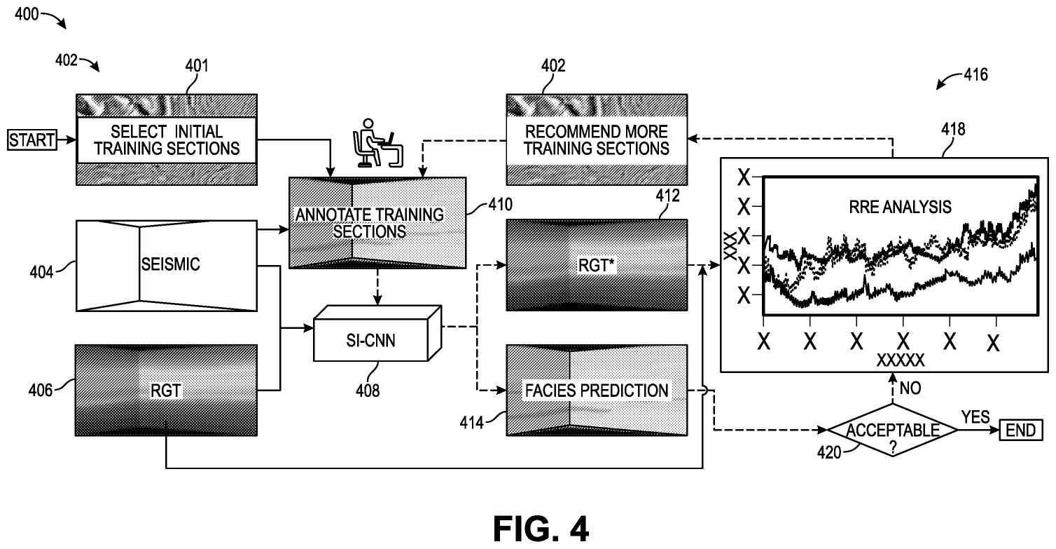

FIG. 4 illustrates a functional block diagram of a workflow 400 for generating a seismic interpretation of a subsurface volume using adaptive learning, according to an embodiment. In particular, the workflow 400 may use iterative seismic image interpretation, such as facies classification (e.g., generating a facies model/image of an area), using active learning. Embodiments of the disclosure may include interpretation (e.g., seismic interpretation) workflows that implement a relative geologic time (RGT)-reconstruction-error (RRE) based scheme that is capable of automatically evaluating the machine prediction and recommending a training section for next iteration. In other embodiments, other attributes, e.g., seismic attributes, could be employed in lieu of or in addition to RGT for the purpose of evaluating error in another attribute (e.g., image) or with a facies model.

The workflow 400 includes data preparation or ingestion stage 402. In this stage 402, an initial training section 401 of a seismic data set may be selected, e.g., by a human operator or a machine learning model, as will be discussed in greater detail below. The workflow 400 may also include receiving seismic data (e.g., seismic amplitude) 404 and one or more attributes 406, such as relative geologic time (RGT), corresponding to the selected training sections 401 (e.g., representing the same volume of interest). It will be appreciated that one or more other attributes may be used, in addition to or instead of RGT, such as structural dips, horizon and/or fault interpretations. It will thus be appreciated that although RGT is used to describe the present workflow 400, other attributes may be employed. It will also be appreciated that although facies classification is used to describe an embodiment of the present workflow, embodiments of the workflow may be readily tailored for other seismic image interpretation tasks.

The seismic data 404 and attribute 406 (e.g., RGT) may be used for training a machine learning model 408, such as a seismic interpretation (SI) convolutional neural network (CNN), to name one specific example. The machine learning model 408 may quantify the prediction errors and recommend sections for next-iteration of SI-CNN training. In addition are a few sections, which could be selected by either manual screening or clustering-based recommendation, which will be annotated and used for initializing the iterative process, as shown.

The workflow 400 may also include a label annotation stage 410. In this stage 410, an interpreter applies his or her knowledge of the seismic interpretation (e.g., a previously constructed facies model) in the selected training sections 401 and annotates a portion of the seismic data therein. For example, the annotations may represent the locations of features of interest in the seismic data. The annotations are digitalized and provided to the machine learning model 408 for training purposes, as shown. The manual annotation in stage 410 may be comprehensive at individual sections and generally consistent across sections.

Next, the workflow 400 includes training the machine learning model 408. In an embodiment, the machine learning model 408 may be a “dual task” SI-CNN. An example architecture for the dual task SI-CNN is discussed below. As a dual task SI-CNN, the machine learning model 408 may be configured to receive two sources of input (e.g., seismic data 404 and an attribute 406 such as RGT). The seismic data 404 may be annotated by a human user, with the annotations indicating locations of features (e.g., faults, horizons, salt bodies, etc.). From this input, the machine learning model 408 may predict an interpretation 414 (e.g., facies model) identifying features in the seismic data, e.g., extending the annotations provided by the human user. The machine learning model 408 may also reconstruct the original attribute (RGT) based at least in part on the facies model (e.g., as a convolution with the facies model). This reconstructed RGT is represented as RGT* (reference number 412) in FIG. 4. The output of the machine learning model may thus be two subsurface models or “cubes” representing two different, but related, aspects of the subsurface. That is, in this specific embodiment, the RGT* 412 and the facies model 414.

The workflow 400 may also include a “quality control” stage 416. In this stage, the workflow 400 may include reviewing and evaluating cubes predicted by the machine learning model. For example, the reconstructed attribute 412 may be compared to the attribute 406 as it was received as input, in order to estimate the accuracy of the predicted interpretation 414 (e.g., facies model). This accuracy may be quantified in an RGT-reconstruction error (RRE) analysis 418 and used to identify areas in the seismic volume where additional training labels would be beneficial, thereby enhancing the efficiency of the iterative, adaptive learning process by potentially identifying areas where additional labels are impactful. If the accuracy is acceptable, as determined at 420, the predicted interpretation 414 (e.g., facies model) can then be exported for future interpretation modules and tasks. Otherwise, the workflow 400 may revert to adding more training sections 422 as recommended using, e.g., an automated scheme, as will be described in greater detail below, to expand the training data, enhance the capability of the machine learning model 408 (e.g., SI-CNN) in learning, and improve the accuracy of machine prediction.

More specifically, for automated 2D section recommendation, a reconstruction error may be calculated, as represented by the RRE analysis 418 in FIG. 4. In the present, specific embodiment, the RRE may be calculated along inline and crossline directions, respectively, as:

$${RRE}_{i} = {\sum }_{j , k} ‖ {R}_{i , j , k} - {R}_{i , j , k}^{*} ‖ , \qquad ( 1 )$$

$$and$$

$${RRE}_{j} = {\sum }_{i , k} ‖ {R}_{i , j , k} - {R}_{i , j , k}^{*} ‖ , \qquad ( 2 )$$

where i, j, and k denote the inline, crossline and vertical dimensions of the seismic survey.

As will be discussed in greater detail below, because both the predicted interpretation 414 (e.g., facies model) and reconstructed attribute 412 (e.g., RGT*) originate from the same encoder-decoder block in the machine learning model 408, mis-predictions in the predicted interpretation 414 may be traceable in the reconstructed attribute 412. In some embodiments, the difficulty in reconstructing the attribute (e.g., matching the reconstructed attribute 412 with the input attribute 406) may be directly related to the accuracy of the predicted interpretation 414. Accordingly, a reconstruction error curve may be employed to sort the sections (e.g., areas in the subsurface) according to complexity for a machine to learn and capture, identify the sections that have been least learned by the machine, and add them into the library of training data for the next iteration of machine learning training and prediction.

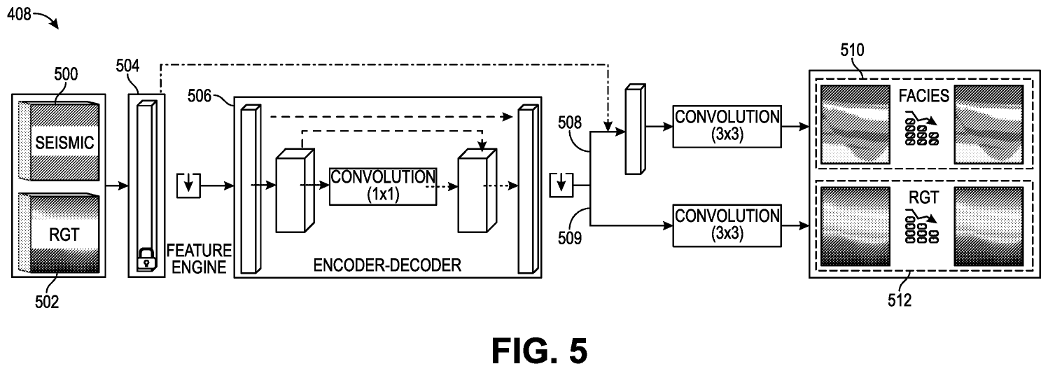

FIG. 5 illustrates an example architecture for the machine learning model 408 (e.g., SI-CNN) discussed above in the context of the workflow of FIG. 4, according to an embodiment. As shown, the machine learning model 408 may receive seismic data 500 and an attribute 502 (e.g., RGT) as input features, along with human-provided annotations as the target of learning. Specifically, the machine learning model 408 may start with a pre-trained feature engine 504 that learns from the input seismic data 500 and attribute 502. The machine learning model 408 may also include an encoder-decoder 506, which may include one or more blocks for multi-scale feature extraction.

The machine learning model 408 may further include two output branches 508, 509. The output branch 508 may generate a predicted facies model 510, e.g., to match the expert annotations on the provided training sections, and the output branch 509 may reconstruct the attribute 502, yielding a reconstructed attribute 512.

Using the attribute-constrained, machine learning model 408 (e.g., an RGT-constrained, SI-CNN) may enforce the lateral consistency of seismic patterns preserved in the attribute 502 (RGT) while building the mapping relationship between the seismic data 500 and the predicted facies model 510 and thus leading to improved machine prediction, as discussed above. Moreover, as also noted above, errors in the attribute reconstruction may be fed back to the same block of the encoder-decoder 506, and thus employed to identify corresponding areas in the interpretation prediction (e.g., the predicted facies model 510) that are poorly interpreted, so that areas for additional training can be identified quantitatively and automatically.

Referring again to FIG. 4, embodiments of the workflow 400 may improve machine learning-based seismic facies classification (and/or other types of interpretation) by integrating active learning with automated training data recommendation. Using the RGT-constrained dual-task SI-CNN as the machine learning model 408, for example, the curve of attribute (RGT) reconstruction error with respective to section is observed to be indicative of how accurate the machine learning prediction is, per section, and thus can be used for fast screening and recommending sections for a next-iteration of training/learning.

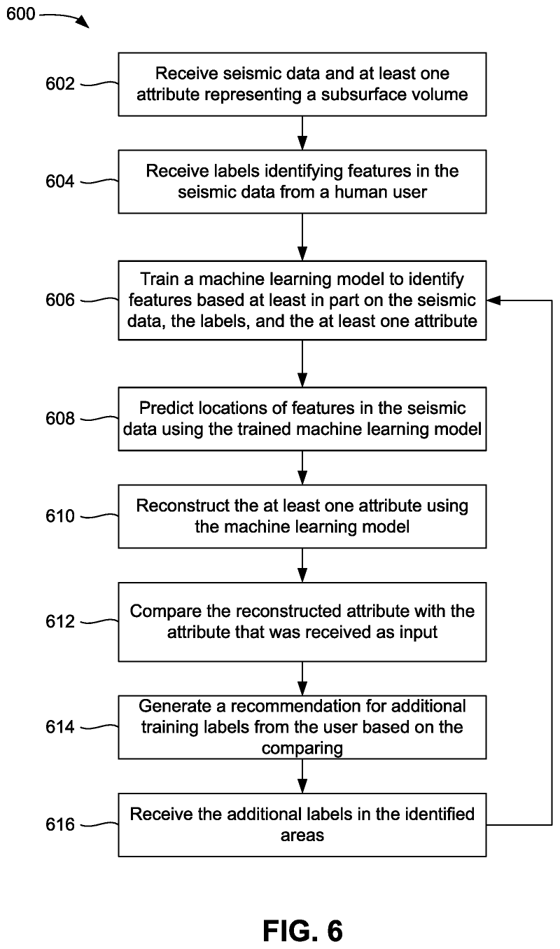

FIG. 6 illustrates a flowchart of a method 600 for generating a model (e.g., a facies model or any other seismic interpretation) of a subsurface volume, according to an embodiment. The model may be implemented in seismic processing workflows, such as the workflows provided above. Further, the model that is generated may be visualized and used in making determinations about operations in or above the subsurface, such as well location, drilling, and construction. Other operations may also include embodiments of the present method, such as geothermal, solar, wind, or any other structural engineering projects in which characterizing the subsurface is employed.

The method 600 may include receiving seismic data (e.g., seismic amplitude measured by one or more geophones in a seismic survey) and at least one other attribute, which both represent the same (or at least partially the same) subsurface volume, as at 602. The at least one other attribute may be or include RGT and/or other attributes/inputs, as noted above.

The method 600 may further include receiving labels identifying features in the seismic data from a human user, as at 604. The labels may be configured to be broadly representative of the seismic volume, but, because the seismic volume may have different levels of complexity in different areas, the labels may be unequally distributed in order to capture such complexity. In at least some embodiments, the labels are generated at multiple times, in response to feedback, as will be discussed in greater detail below.

The method 600 may also include training a machine learning model (e.g., an SI-CNN) to identify features based at least in part on the seismic data, the labels, and the at least one attribute, as at 606. The machine learning model may convolve the annotated seismic data and the attribute in an encoder-decoder block.

The method 600 may also include predicting locations of features in the seismic data using the trained machine learning model, as at 608. This may provide a “predicted interpretation”, e.g., a facies model, among other possibilities, providing locations and/or other characteristics of features, such as faults, salt domes, etc., in the subsurface volume.

The method 600 may also include reconstructing the at least one attribute using the machine learning model, as at 610. As noted above, the two tasks of the machine learning model (identifying features and reconstructing the attribute) may be performed by the same encoder-decoder. As such, errors in one output result may indicate errors in the other output. This may indicate particular sections in the subsurface volume where the machine learning model is not accurately predicting the presence of features, e.g., because the machine learning model is not well trained for the geological complexities in that particular section.

The method 600 may include comparing the reconstructed attribute with the attribute that was provided as input, as at 612. Based on the comparison, the method 600 may identify one or more sections in the seismic data in which the machine learning model is not sufficiently accurate in its interpretations (e.g., not sufficiently trained), and/or one or more sections in which the machine learning model is sufficiently accurate. The sufficiency of the accuracy, and thus the training in the related sections, may be determined at least in part based on the accuracy value calculated, e.g., using equations (1) and (2) above.

In some embodiments, sections with the largest inconsistency may be identified for labeling first, e.g., a ranking scheme may be implemented. In other embodiments, any sections that have an inconsistency that exceeds a certain threshold may be flagged for additional labelling. In other embodiments, any sort of identification technique that is based upon the quantitative consistency may be used. Additionally, sections in the seismic data for which the machine learning model does accurately interpret the data may be determined, and no further training labels may be called for in these sections, or additional labels may be considered a lower priority, in at least some embodiments.

The method 600 may proceed to generating a recommendation for additional training labels from the user (e.g., a human interpreter) based on the comparing, as at 614. In particular, the recommendation may be for additional training labels in the sections identified where the machine learning model's interpretations are not sufficiently accurate. The method 600 may then receive the labels, as at 616, in response to the recommendation, from an interpreter. The method 600 may return to training (in this case, retraining) the machine learning model (e.g., the SI-CNN) as discussed above, as at 606. The method 600 may then proceed again through the training, predicting, and reconstructing, and again determine the consistency. This process may repeat until an exit condition is met, such as the maximum inconsistency being below a certain threshold, a certain number of iterations being reached, or any statistical measure being satisfied. The method 600 may also, in some embodiments, including visualizing the predicted interpretation, the reconstructed attribute, or both, so as to facilitate operations in the field, e.g., well location, planning, drilling, completion, treatment, etc., and/or any other construction project, such as wind, solar, or geothermal facilities construction.

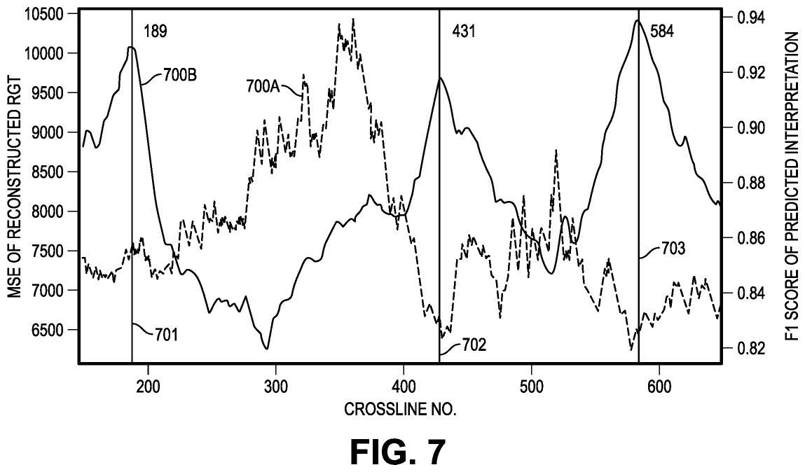

FIG. 7 illustrates a plot 700A of the mean square error of the reconstructed RGT (e.g., an RRE plot) and a plot 700B of the F1 score of the predicted interpretation by cross-line, according to an embodiment. In this example, three training cross-lines were selected and annotated by a human operator, and used to train the machine learning model that generated the reconstructed RGT and the predicted interpretation. These three cross-lines are indicated as 701, 702, 703. As can be seen, the plot 700B indicates the highest F1 scores at the cross-lines 701, 702, 703, and the plot 700A indicates the lowest error values at the cross-lines 701, 702, 703. Between the cross-lines 701, 702, 703, the error increases and the F1 score reduces. Thus, the plots 700A, 700B demonstrate that zones where the RGT is not well reconstructed (high RGT error) are also those of poor machine prediction (low F1 score). Therefore, in the cases of no manual annotation for machine prediction validation, the RRE curve (the MSE of the Reconstructed RGT) may be used to rapidly sort sections according to their complexities for a machine to learn and capture, to roughly identify the sections that have been least learned by the machine, and to add those least-learned sections to the library of training data for the next iteration of training and prediction.

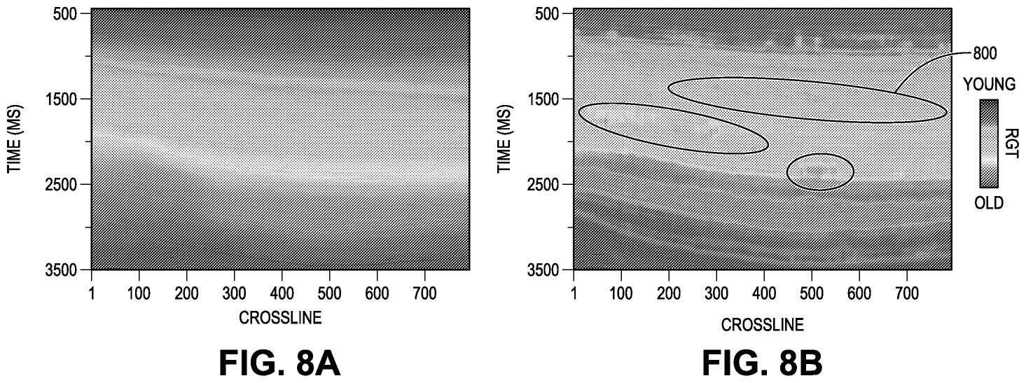

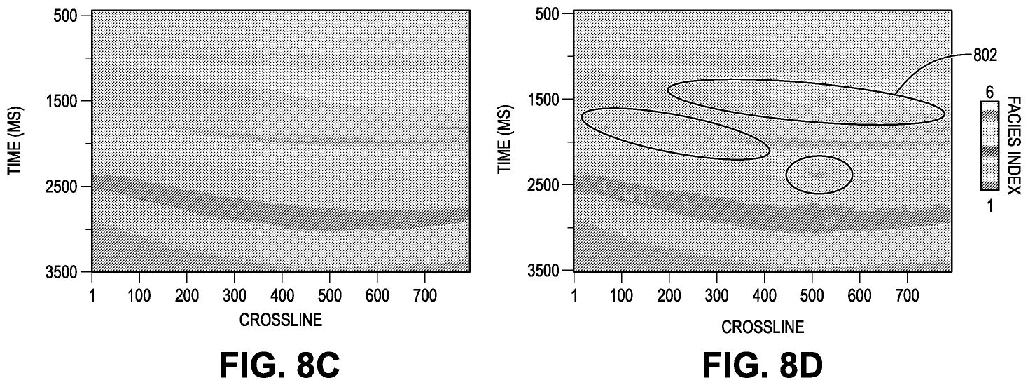

FIGS. 8A and 8B depict an actual (e.g., input) RGT attribute and a reconstructed RGT attribute, respectively, according to an example. FIGS. 8C and 8D illustrate an actual (input) facies model, and a predicted facies model, respectively, according to an example. In FIG. 8B, circles 800 indicate areas of high error between the RGT of FIGS. 8A and 8B. Circles 802, in FIG. 8D indicate the same regions in the predicted facies model, showing errors/artifacts not contained in the input facies model of FIG. 8C, and thus representing inconsistencies. This further demonstrates that high RGT error indicates areas where the facies model interpretation is relatively inaccurate, and thus would benefit from additional training.

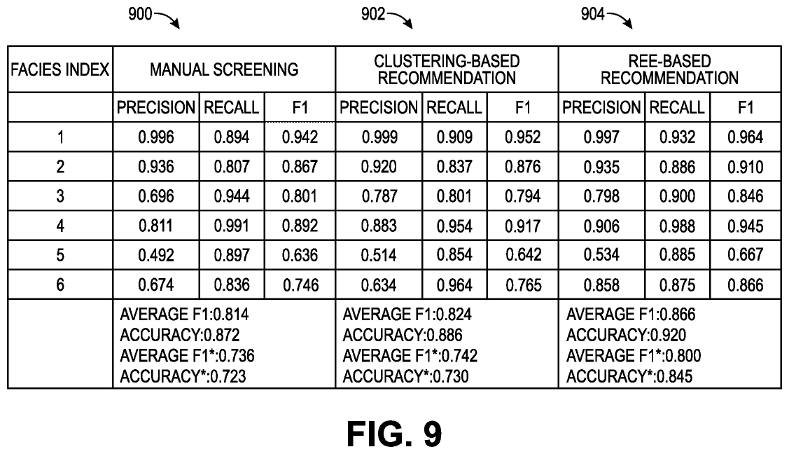

FIG. 9 illustrates a table of statistical measures of three different regimes for selecting training data and iterating through the interpretation workflow, according to an embodiment. The first regime 900 is manual screening, that is, where a human user selects the next cross-lines for annotation and training. The second regime 902 is a clustering-based recommendation, e.g., where the computer selects the next training sections based on the relative characteristics of the interpretation. The third regime 904 employs RRE-based selection, e.g., using the workflow discussed herein, in which the sections to train are selected based on the error in reconstructing a seismic attribute, such as RGT. As can be seen by comparing the results of the three different regimes, the F1 scores and accuracy in the RRE-based selection exceed those of the other two regimes.

In one or more embodiments, the functions described can be implemented in hardware, software, firmware, or any combination thereof. For a software implementation, the techniques described herein can be implemented with modules (e.g., procedures, functions, subprograms, programs, routines, subroutines, modules, software packages, classes, and so on) that perform the functions described herein. A module can be coupled to another module or a hardware circuit by passing and/or receiving information, data, arguments, parameters, or memory contents. Information, arguments, parameters, data, or the like can be passed, forwarded, or transmitted using any suitable means including memory sharing, message passing, token passing, network transmission, and the like. The software codes can be stored in memory units and executed by processors. The memory unit can be implemented within the processor or external to the processor, in which case it can be communicatively coupled to the processor via various means as is known in the art.

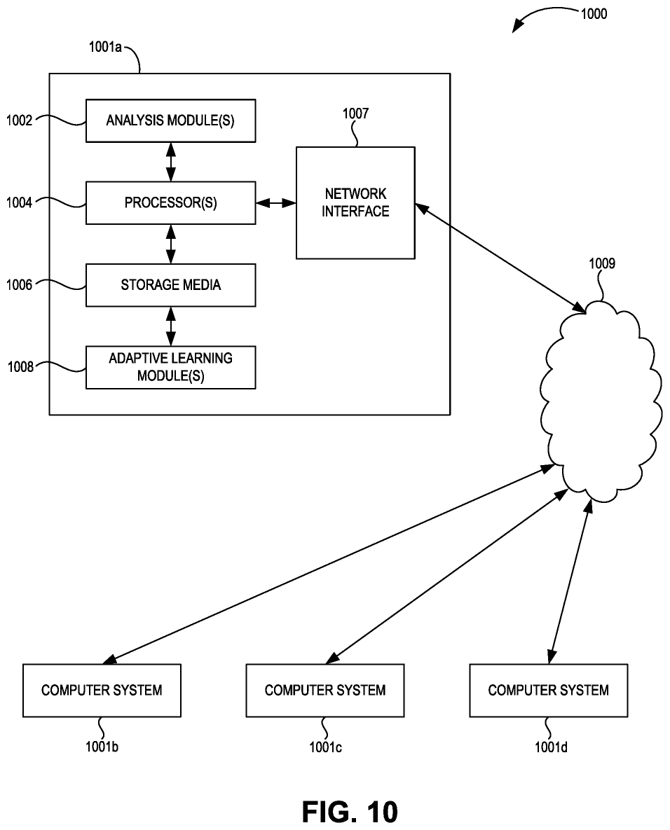

In some embodiments, any of the methods of the present disclosure may be executed using a system, such as a computing system. FIG. 10 illustrates an example of such a computing system 1000, in accordance with some embodiments. The computing system 1000 may include a computer or computer system 1001a, which may be an individual computer system 1001a or an arrangement of distributed computer systems. The computer system 1001a includes one or more analysis module(s) 1002 configured to perform various tasks according to some embodiments, such as one or more methods disclosed herein. To perform these various tasks, the analysis module 1002 executes independently, or in coordination with, one or more processors 1004, which is (or are) connected to one or more storage media 1006. The processor(s) 1004 is (or are) also connected to a network interface 1007 to allow the computer system 1001a to communicate over a data network 1009 with one or more additional computer systems and/or computing systems, such as 1001b, 1001c, and/or 1001d (note that computer systems 1001b, 1001c and/or 1001d may or may not share the same architecture as computer system 1001a, and may be located in different physical locations, e.g., computer systems 1001a and 1001b may be located in a processing facility, while in communication with one or more computer systems such as 1001c and/or 1001d that are located in one or more data centers, and/or located in varying countries on different continents).

A processor can include a microprocessor, microcontroller, processor module or subsystem, programmable integrated circuit, programmable gate array, or another control or computing device.

The storage media 1006 can be implemented as one or more computer-readable or machine-readable storage media. Note that while in the example embodiment of FIG. 7 storage media 1006 is depicted as within computer system 1001a, in some embodiments, storage media 1006 may be distributed within and/or across multiple internal and/or external enclosures of computing system 1001a and/or additional computing systems. Storage media 1006 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In some embodiments, computing system 1000 contains one or more adaptive learning module(s) 1008. In the example of computing system 1000, computer system 1001a includes the adaptive learning module 1008. In some embodiments, a single adaptive learning module may be used to perform some or all aspects of one or more embodiments of the methods. In alternate embodiments, a plurality of adaptive learning modules may be used to perform some or all aspects of methods.

It should be appreciated that computing system 1000 is only one example of a computing system, and that computing system 1000 may have more or fewer components than shown, may combine additional components not depicted in the example embodiment of FIG. 10, and/or computing system 1000 may have a different configuration or arrangement of the components depicted in FIG. 10. The various components shown in FIG. 10 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention.

Geologic interpretations, models and/or other interpretation aids may be refined in an iterative fashion; this concept is applicable to embodiments of the present methods discussed herein. This can include use of feedback loops executed on an algorithmic basis, such as at a computing device (e.g., computing system 1000, FIG. 10), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. Moreover, the order in which the elements of the methods are illustrated and described may be re-arranged, and/or two or more elements may occur simultaneously. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method, comprising:
receiving seismic data and an attribute, the seismic data and the attribute representing a subsurface volume;
receiving training labels for the seismic data;
training a machine learning model to identify features in the subsurface volume and to reconstruct the attribute, based at least in part on the seismic data and the training labels;
generating an interpretation by predicting features in the subsurface volume using the machine learning model;
generating a reconstructed attribute using the machine learning model;
comparing the reconstructed attribute with the attribute that was received to identify one or more sections of the subsurface volume; and
generating a recommendation to acquire additional training labels in the one or more sections that were identified.

2. The method of claim 1, wherein identifying the one or more sections comprises calculating a consistency value for the one or more sections based on the comparing, and selecting the one or more sections based at least in part on the consistency value being relatively low compared to a consistency value of one or more other sections.

3. The method of claim 2, wherein the interpretation is not directly compared with the seismic data to identify the one or more sections.

4. The method of claim 1, wherein the attribute is selected from the group consisting of relative geologic time and structural dip, and wherein the interpretation comprises a facies model.

5. The method of claim 1, wherein the machine learning model comprises an encoder-decoder block that is configured to at least partially generate the interpretation and at least partially generate the reconstructed attribute.

6. The method of claim 1, further comprising:
receiving the training labels in response to the recommendation to acquire the additional training labels; and
training the machine learning model based at least in part on the training labels received in response to the recommendation and at least a portion of the seismic data that represents the identified one or more sections.

7. The method of claim 1, further comprising visualizing the interpretation, the reconstructed attribute, or both.

8. A computing system, comprising:
one or more processors; and
a memory system comprising one or more non-transitory, computer-readable media storing instructions that, when executed by at least one of the one or more processors, cause the system to perform operations, the operations comprising:
receiving seismic data and an attribute, the seismic data and the attribute representing a subsurface volume;
receiving training labels for the seismic data;
training a machine learning model to identify features in the subsurface volume and to reconstruct the attribute, based at least in part on the seismic data and the training labels;
generating an interpretation by predicting features in the subsurface volume using the machine learning model;
generating a reconstructed attribute using the machine learning model;
comparing the reconstructed attribute with the attribute that was received to identify one or more sections of the subsurface volume; and
generating a recommendation to acquire additional training labels in the one or more sections that were identified.

9. The computing system of claim 8, wherein identifying the one or more sections comprises calculating a consistency value for the one or more sections based on the comparing, and selecting the one or more sections based at least in part on the consistency value being relatively low compared to a consistency value of one or more other sections.

10. The computing system of claim 9, wherein the interpretation is not directly compared with the seismic data to identify the one or more sections.

11. The computing system of claim 8, wherein the attribute is selected from the group consisting of relative geologic time and structural dip, and wherein the interpretation comprises a facies model.

12. The computing system of claim 8, wherein the machine learning model comprises an encoder-decoder block that is configured to at least partially generate the interpretation and at least partially generate the reconstructed attribute.

13. The computing system of claim 8, wherein the operations further comprise:
receiving the training labels in response to the recommendation to acquire the training labels; and
training the machine learning model based at least in part on the training labels received in response to the recommendation and at least a portion of the seismic data that represents the identified one or more sections.

14. The computing system of claim 8, wherein the operations further comprise visualizing the interpretation, the reconstructed attribute, or both.

15. A non-transitory, computer readable medium storing instructions that, when executed by at least one processor of a computing system, cause the computing system to perform operations, the operations comprising:
receiving seismic data and an attribute, the seismic data and the attribute representing a subsurface volume;
receiving training labels for the seismic data;
training a machine learning model to identify features in the subsurface volume and to reconstruct the attribute, based at least in part on the seismic data and the training labels;
generating an interpretation by predicting features in the subsurface volume using the machine learning model;
generating a reconstructed attribute using the machine learning model;
comparing the reconstructed attribute with the attribute that was received to identify one or more sections of the subsurface volume; and
generating a recommendation to acquire training labels in the one or more sections that were identified.

16. The medium of claim 15, wherein identifying the one or more sections comprises calculating a consistency value for the one or more sections based on the comparing, and selecting the one or more sections based at least in part on the consistency value being relatively low compared to a consistency value of one or more other sections.

17. The medium of claim 16, wherein the interpretation is not directly compared with the seismic data to identify the one or more sections.

18. The medium of claim 15, wherein the attribute is selected from the group consisting of relative geologic time and structural dip, and wherein the interpretation comprises a facies model.

19. The medium of claim 15, wherein the machine learning model comprises an encoder-decoder block that is configured to at least partially generate the interpretation and at least partially generate the reconstructed attribute.

20. The medium of claim 15, wherein the operations further comprise:
receiving the training labels in response to the recommendation to acquire the training labels; and
training the machine learning model based at least in part on the training labels received in response to the recommendation and at least a portion of the seismic data that represents the identified one or more sections; and
visualizing the interpretation, the reconstructed attribute, or both.
